(19) United States
(12) Patent Application Publication
(10) Pub. No.: US 2026/0065560 A1
(43) Pub. Date: Mar. 5, 2026

(54) DIGITIZATION FOR AI FILMMAKING IN COLLABORATIVE NETWORKS

(71) Applicant: TCL Research America Inc., San Jose, CA (US)

(72) Inventor: Haohong Wang, San Jose, CA (US)

(73) Assignee: TCL Research America Inc., San Jose, CA (US)

(21) Appl. No.: 18/961,455

(22) Filed: Nov. 27, 2024

Related U.S. Application Data
(60) Provisional application No. 63/690,207, filed on Sep. 3, 2024.

(51) Int. Cl. G06T 13/20; G06T 11/00; G06T 17/00

(52) U.S. Cl. CPC G06T 13/20; G06T 11/00; G06T 17/00; G06T 2211/441

(57) ABSTRACT

This disclosure provides an AI filmmaking workflow including AI-assisted storyboarding, AI animation, and post-production processes for creating films. The workflow provides techniques for reconstructing 3D digital environments and characters, and for virtual camera control. The workflow also provides techniques for capturing 2D live-action performances and extracting visual cues. The AI animation process generates synthetic images and video using prompts that are based on virtual camera control in case of 3D digitization and/or visual cues in case of 2D camera capturing. Further, the workflow provides techniques for compositing with AI assistance, to generate a composited video based on the AI-animated video and inputs resulting from 3D digitization and/or 2D video processing. Advanced post-processing techniques are also provided for generating a complete film based on the composited video. This framework is designed to facilitate creative collaborative networks by using a hybrid digitization approach to enhance consistency, directability, and scalability in AI filmmaking.

### CROSS REFERENCE TO RELATED APPLICATION

This application claims the benefit of U.S. Provisional Application No. 63/690,207 filed on Sep. 3, 2024, the entire contents of which are incorporated by reference herein.

### FIELD OF THE DISCLOSURE

The present disclosure relates to digitization techniques for use in AI-assisted filmmaking, and more particularly, to an AI filmmaking workflow platform for implementing creative collaborative networks.

### BACKGROUND

In recent years, several artificial intelligence (AI) initiatives have been explored to automate filmmaking processes. By 2023, some AI tools like Runway and Pika enabled users to create short, photorealistic, professional-quality videos using text or image prompts. In February 2024, OpenAI introduced Sora, which can generate high-quality videos up to 60 seconds long. Subsequently, tools like Luma, Kling, and Vidu were developed, further establishing a solid foundation for advancing practical AI filmmaking workflows.

However, at least two major challenges in AI filmmaking remain unresolved and are often overlooked-directability and scalability. Current AI tools fall short in addressing directability, limiting filmmakers' ability to exercise the level of control and precision needed to produce high-quality films. These tools primarily focus on generating short, realistic clips but often neglect the precise control and the consistency required to maintain a cohesive narrative. Scalability, on the other hand, involves creating a filmmaking workflow that facilitates seamless remote collaboration among filmmakers and artists, which is crucial for realizing the full potential of AI-assisted filmmaking. The lack of process in these areas is likely due to the current limitations of AI technology, which still struggles to support artists in producing high-quality films relatively easily. Consequently, this might explain the scarcity of AI-generated video content from legacy studios and distributors.

### SUMMARY

To address the above needs and overcome shortcomings of existing AI tools, the present disclosure provides systems and methods that integrate digitization techniques into an AI-assisted filmmaking workflow, which can be used for implementing creative collaborative networks.

According to an aspect of the present disclosure, a computer-implemented system for artificial intelligence (AI) assisted filmmaking is provided. The system includes: an AI-assisted storyboarding module configured to generate one or more images of a storyboard, one or more prompts associated with the storyboard, and a guide based on a script; a 3D digitization module configured to generate a 3D model for a scene based on the script and the guide; a virtual camera controller configured to generate a prompt associated with the 3D model for the scene for controlling virtual camera settings; an AI animation module configured to generate a first video based on the one or more images of the storyboard and the one or more prompts associated with the storyboard, as well as the prompt associated with the 3D model for the scene for controlling the virtual camera settings; and an AI-assisted compositing module configured to generate a composited video based on the first video generated by the AI animation module and a low-rank adaptation (LoRA) model.

In some examples, the 3D digitization module is further configured to generate the LoRA model based on the script and the guide, wherein the 3D model for the scene represents a digitized 3D environment and the LoRA model represents a digitized character.

In some examples, the system further includes: a 2D camera capturing module configured to generate a second video based on the script and the guide; and a visual cue extraction module configured to generate a prompt associated with the second video.

In some examples, the AI animation module is configured to generate the first video based on the one or more images of the storyboard and the one or more prompts associated with the storyboard, as well as the prompt associated with the second video.

In some examples, the visual cue extraction module is further configured to generate one or more visual cues based on the second video, and the system further includes a video processing module configured to generate a third video based on the second video and the one or more visual cues.

In some examples, the AI-assisted compositing module is further configured to generate the composited video based on the first video generated by the AI animation module and the third video generated by the video processing module.

In some examples, the AI-assisted compositing module is further configured to add visual effects, sound effects, or a combination thereof in the composited video.

In some examples, the system further includes a post-production module configured to generate and output a complete film based on the composited video generated by the AI-assisted compositing module.

In some examples, the post-production module is configured to perform one or more post-processing operations with respect to the composited video generated by the AI-assisted compositing module to generate the complete film.

According to another aspect of the present disclosure, a computer-implemented method for artificial intelligence (AI) assisted filmmaking if provided. The method includes: generating, via an AI-assisted storyboarding module, one or more images of a storyboard, one or more prompts associated with the storyboard, and a guide based on a script; generating, via a 3D digitization module, a 3D model for a scene based on the script and the guide; generating, via a virtual camera controller, a prompt associated with the 3D model for the scene for controlling virtual camera settings; generating, via an AI animation module, a first video based on the one or more images of the storyboard and the one or more prompts associated with the storyboard, as well as the prompt associated with the 3D model for the scene for controlling the virtual camera settings; and generating, via an AI-assisted compositing module, a composited video based on the first video and a low-rank adaptation (LoRA) model.

In some examples, the method further includes generating, via the 3D digitization module, the LoRA model based on the script and the guide, wherein the 3D model for the scene represents a digitized 3D environment and the LoRA model represents a digitized character.

In some examples, the method further includes: generating, via a 2D camera capturing module, a second video based on the script and the guide; and generating, via a visual cue extraction module, a prompt associated with the second video.

In some examples, the method further includes generating, via the AI animation module, the first video based on the one or more images of the storyboard and the one or more prompts associated with the storyboard, as well as the prompt associated with the second video.

In some examples, the method further includes: generating, via the visual cue extraction module, one or more visual cues based on the second video; and generating, via a video processing module, a third video based on the second video and the one or more visual cues.

In some examples, the method further includes includes generating, via the AI-assisted compositing module, the composited video based on the first video and the third video.

In some examples, the method further includes adding, via the AI-assisted compositing module, visual effects, sound effects, or a combination thereof in the composited video.

In some examples, the method further includes: generating, via a post-production module, a complete film based on the composited video; and outputting the complete film for review.

In some examples, the method further includes: performing, via the post-production module, one or more post-processing operations with respect to the composited video to generate the complete film.

Beneficial Effect: The present disclosure provides an AI filmmaking workflow including AI-assisted storyboarding, AI animation, and post-production processes for creating films. The workflow provides techniques for reconstructing 3D digital environments and characters, and for virtual camera control. The workflow also provides techniques for capturing 2D live-action performances and extracting visual cues. The AI animation process generates synthetic images and video using prompts that are based on virtual camera control in case of 3D digitization and/or visual cues in case of 2D camera capturing. Further, the workflow provides techniques for compositing with AI assistance, to generate a composited video based on the AI-animated video and inputs resulting from 3D digitization and/or 2D video processing. Advanced post-processing techniques are also provided for generating a complete film based on the composited video. This framework is designed to facilitate creative collaborative networks by using a hybrid digitization approach to enhance consistency, directability, and scalability in AI filmmaking.

### BRIEF DESCRIPTION OF THE DRAWINGS

FIG. 1 is an algorithmic diagram illustrating an AI filmmaking workflow according the current state-of-the-art;

FIG. 2 is an algorithmic diagram illustrating an AI filmmaking workflow according to a first example embodiment of the present disclosure;

FIG. 3 is an algorithmic diagram illustrating an AI filmmaking workflow according to a second example embodiment of the present disclosure;

FIG. 4 is an algorithmic diagram illustrating an AI filmmaking workflow according to a third example embodiment of the present disclosure;

FIG. 5A and FIG. 5B are images of a 3D scene, each image with a different background created using Gaussian splatting, with the same human elements added into the 3D space, according to an aspect of the present disclosure;

FIG. 6A is a 2D image before processing;

FIG. 6B is a regenerated 2D image from a different camera setting;

FIG. 6C is a reconstructed 3D depth model under camera control by using monocular depth estimation;

FIG. 6D is a reconstructed 3D space under camera control (virtual camera), according to an aspect of the present disclosure;

FIG. 7A is a set of images in rows and columns, with each row corresponding to a person and each column corresponding to different appearances, to illustrate digitizing human appearance with various different character customizations, according to an aspect of the present disclosure;

FIG. 7B is a set of three images to illustrate replacing a human face with a digitized 3D model, according to an aspect of the present disclosure;

FIG. 8A is an image showing an actor performance captured with a 2D camera to use as a reference according to an aspect of the present disclosure;

FIG. 8B is an image showing an AI-generated character in a different background environment and using the same style of movements as the actor performance of FIG. 8A to use as a motion prompt according to an aspect of the present disclosure;

FIG. 9A is a set of images to illustrate a compositing process that integrates the performance of real human actors, a stable AI-generated background, and moving window scenes into a single frame, according to an aspect of the present disclosure;

FIG. 9B and FIG. 9C show two different viewing angles of the compositing process with multiple layers of objects, respectively, according to an aspect of the present disclosure;

FIG. 10 is a conceptual diagram illustrating an AI film composition process using the AI filmmaking workflow in a collaborative network, according to aspects of the present disclosure;

FIG. 11 is a structural diagram illustrating a creative collaborative network including an AI filmmaking workflow platform according to aspects of the present disclosure;

FIG. 12 is a flowchart illustrating steps of a first method for AI-assisted filmmaking, according to the first example embodiment of the present disclosure;

FIG. 13 is a flowchart illustrating steps of a second method for AI-assisted filmmaking, according to the second example embodiment of the present disclosure; and

FIG. 14 is a flowchart illustrating steps of a third method for AI assisted filmmaking, according to the third example embodiment of the present disclosure.

### DETAILED DESCRIPTION

### 1. Overview

The present application introduces a novel AI filmmaking framework that is designed to facilitate future creative collaborative networks. The AI filmmaking workflow platform described herein uses a hybrid digitization approach that involves reconstructing 3D digital environments, capturing 2D live-action performances, employing AI tools to generate synthetic images and videos, and compositing with AI assistance. The AI filmmaking workflow platform and the corresponding techniques for creating AI films described herein provide a comprehensive solution to effectively address the main challenges in current AI video generation, including but not limited to consistency, directability, scalability, and issues with human actions and interactions, and has the potential to be a pioneering trailblazer in the AI filmmaking industry.

Digitization offers a powerful solution to the challenges of directability and scalability in AI filmmaking. By digitizing 3D elements like human characters and backgrounds, the AI filmmaking workflow can reconstruct the 3D environment, enabling virtual cameras to be positioned anywhere for dynamic frame generation. This approach allows filmmakers to bypass the camera control limitations of current AI tools, providing greater flexibility, precision, and creativity in camera work, and supporting more complex and innovative visual storytelling techniques. Furthermore, digitization transforms collaborative networks, enabling more dynamic, inclusive, and effective teamwork. Digital tools remove the constraints of time zones and office hours, allowing teams to work asynchronously and hand off tasks seamlessly across different time zones, ensuring continuous project progress.

As noted, digitization is a key component for enhancing directability and offering greater control over the filmmaking process. Example embodiments of the present disclosure can overcome consistency and camera control challenges by utilizing multiple types of prompts from the various digitization processes to animate keyframes more effectively. These prompts guide camera settings, storytelling, and the styling of characters and/or background elements. By integrating these diverse prompts, filmmakers can achieve greater control over the AI pipeline.

To the best of the inventor's knowledge, the AI filmmaking workflow described herein is the first comprehensive solution to tackle the key challenges in AI filmmaking of consistency, directability, and scalability. The main contributions of the AI filmmaking workflow platform of the present application are as follows:
New Framework: The AI filmmaking workflow platform introduces a novel framework to effectively resolve the consistency and directability issues present in current AI filmmaking solutions.
Superior Visual Quality: By combining live-action performances with AI-generated backgrounds and objects, the AI filmmaking workflow platform achieves a higher visual quality in composited films than existing state-of-the-art AI tools.
Enhanced Camera Control: The AI filmmaking workflow significantly improves camera control by incorporating virtual camera settings from the digitization process into the AI animation process.

Before describing further details of the novel AI filmmaking framework according to various example embodiments of the present disclosure, some background information regarding related work in the field as well as various challenges faced by existing AI-based content generation tools will be further explained below to provide additional context and enablement.

### 2. Related Work

2.1 3D World Reconstruction from 2D Images

In AI filmmaking, maintaining precise control over camera motion is crucial, as the director's creative vision for each scene often requires specific camera placements and movements. However, current high-quality image and video generation models face challenges with scene consistency. While AI-generated scenes may be visually impressive, synthesizing alternate views of the same scene can lead to issues such as changes in the 3D environment, removal of objects, and background color variations between scenes. To address this, one effective solution is to separate the 3D environment generation from the foreground elements. By reconstructing the 3D environment, more consistent and adaptable camera movement can be achieved. Thus, the framework described herein depends on 3D scene reconstruction from images to maintain scene coherence.

In the framework of the present disclosure, a state-of-the-art Gaussian Splatting technique can be integrated to digitize background scenes effectively. Gaussian Splatting is a novel approach to 3D scene representation and rendering that has gained significant traction in computer vision and graphics. It offers a compelling solution for digitizing movie environments, enabling precise camera control and facilitating the generation of consistent, conditional content within the captured scene. Gaussian Splatting represents a 3D scene as a set of 3D Gaussian primitives. These 3D Gaussian components are projected on the 2D plane to synthesize a novel view. The rendering process projects these 3D Gaussians onto the image plane.

By utilizing these new views, it becomes possible to simulate camera movements within the reconstructed 3D environment, ensuring a consistent background throughout the film. Additionally, the background's texture can be modified using Stable Diffusion video style transfer models, allowing for the addition or removal of details while maintaining overall consistency.

### 2.2 Stable Diffusion

Diffusion models have emerged as a powerful class of generative models that have gained prominence in recent years, offering a novel approach to high-fidelity in computer vision. These models are grounded in the theoretical framework of Markov chains and stochastic processes. At their core, diffusion models learn to reverse a process of adding noise to training data, generating coherent images from noise. The fundamental principle underlying diffusion models is the gradual application of Gaussian noise to data points (forward diffusion process), followed by learning an iterative denoising process to reverse this diffusion (reverse diffusion process).

Diffusion models have experienced rapid growth and are being applied in various domains such as text-to-image (T2I) generation models, image-to-image (I2I) generation models, text-to-video (T2V) generation models, and 3D synthesis models. The emergence of tools like DALL-E 2, Stable Diffusion, Midjourney, and Google's Imagen have democratized machine learning, empowering users to create diverse images simply from text prompts.

Stable Diffusion models typically operate in a latent space to efficiently process high-dimensional data. Unlike standard diffusion models that operate directly in pixel space, Stable Diffusion leverages a latent image encoding space, reducing memory requirements and computational costs while maintaining high fidelity in the generated images.

Through training, diffusion models learn to predict the noise that was added during the forward diffusion process, and reverse this diffusion process to remove noise from images, using this denoising process to generate realistic images from random seeds. This approach, known as parameterization, has been shown to improve training stability and sample quality. During inference, Stable Diffusion employs a sampling procedure that begins with random noise and iteratively applies the learned reverse process. This basic sampling procedure can be accelerated using techniques such as Denoising Diffusion Implicit Models (DDIM) or Pseudo Linear Multistep (PLMS) methods, which allow for fewer sampling steps without significant loss in sample quality. After the iterative denoising operation is completed, the actual generation occurs in the latent space of a pre-trained Variational Autoencoder (VAE). Once the final latent representation is obtained, it is passed through the VAE decoder to produce the final high-resolution image.

In other words, trained diffusion models can start with a random noise image and some conditioning information (e.g., a user-provided text input describing the desired image, a pose vector from motion capture, a hand-drawn sketch, or another reference video or image), and then a learned iterative denoising procedure can iteratively “denoise” the input signal, ending with a realistic output image.

Diffusion models have traditionally relied on U-Net architectures, which sequentially encode input images into lower-dimensional representations and subsequently decode them back to the original pixel space. Most diffusion models interleave ResNet blocks with Vision Transformer blocks in each layer. Additionally, purely Vision Transformer-based diffusion models have emerged as alternatives to U-Net architectures, demonstrating distinct advantages such as adaptability in generating videos of varying lengths. Latest advancements have expanded diffusion models to incorporate video generation, offering the potential to revolutionize content creation. However, it introduces new challenges like ensuring spatial and temporal consistency, managing computational costs, and generating long video sequences.

To achieve temporal consistency, models need to share information across frames, often involving 3D architectures or factorized approaches to mitigate computational costs, while pre-processed features like depth estimates guide the denoising process for improved results. Typically, modifications are made to the self-attention layers within the U-Net architecture, including using temporal attention, full spatio-temporal attention, causal attention, and sparse causal attention. Each form varies in computational demand and motion capture capability.

In the realm of filmmaking, video length poses a significant challenge. While short clips suffice for trailers or commercials, they fall short of full-length movies. A recent breakthrough, Sora from OpenAI, represents the state-of-the-art in this field. It excels by producing videos up to a minute in length, all while preserving visual fidelity and staying true to the user's input. Another crucial challenge is achieving fine-grained control over content and motion synthesis. Human animation generation plays a pivotal role in maintaining consistent characters between scenes, thereby enhancing immersion and storytelling coherence. Techniques leveraging reference images and motion guidance specific to humans enable direct human animation video generation, facilitating seamless character continuity throughout a film.

Low-rank adaptation (LoRA) is a technique introduced to make the fine-tuning of large-scale models more efficient, particularly in the context of transfer learning. Traditional fine-tuning methods involve adjusting all the parameters of a pre-trained model, which can be computationally expensive and prone to issues like overfitting or catastrophic forgetting, where the model loses the knowledge it gained during pre-training. LoRA addresses these issues by introducing additional trainable parameters in the form of low-rank matrices while keeping the original model weights frozen. This not only reduces the computational cost and memory usage, but also helps preserve the pre-trained knowledge, thereby minimizing the risk of catastrophic forgetting. In LoRA, the original weight matrix of the denoising network is augmented with a low-rank factorization, resulting in an updated weight matrix that serves as the low-rank approximation added to the original weights. LoRA reduces the number of trainable parameters and makes it easy to fine-tune on small datasets. In practice, LoRA is often applied selectively to certain parts of the model, such as the attention layers in Transformer architectures, further reducing the computational and memory requirements for fine-tuning.

In AI-driven filmmaking, LoRA models play a crucial role, as they enable fine-tuning of Stable Diffusion models to capture specific actors and environments. In movie production, digitizing actors is essential for generating content within the described settings. However, gathering large datasets for each actor or environment is often impractical (or even impossible). The LoRA technique allows to fine-tune customized Stable Diffusion models for individual actors and environments, ensuring consistent content generation.

Stable Diffusion models have been extended to the field of conditional video generation following their success in image synthesis. One approach involves adapting pre-trained large Stable Diffusion models for images by converting the network into a 3D model using inflated convolutional layers and fine-tuning on video datasets. This method produces acceptable results for short clip generation without the need to train an expensive video model from scratch. Another approach focuses on enhancing Stable Diffusion's capabilities to synthesize entire video sequences from textual prompts. These models generate a sequence of frames based on an initial noise input and a text prompt. Although this approach can produce high-quality short video clips, it is constrained by GPU memory limitations, making it challenging to generate long, consistent videos. Some commercially available products (e.g., Sora, Runway Gen3, Kling, and Luma) have made efforts to address temporal coherence issues, but they are still largely limited to generating short video clips rather than extended shots and entire films.

### 2.3 AI Content Generation Tools Currently Available to Use

Among the existing AI content generation tools, a distinction can be made between those with open-source models and those with proprietary models that are generally unavailable to the public. The primary advantage of open-source models lies in the opportunity to develop proprietary tools and workflows built upon the open-source model, enabling customization tailored to the specific requirements of filmmaking.

Popular AI content generation tools include, but are not limited to, the following:
Midjourney, which is an advanced AI program that generates images from natural language descriptions. Accessed through a Discord bot, users input prompts to receive sets of images, facilitating rapid prototyping.
OpenAI's DALL-E 2 and its successor DALL-E 3, which is constructed on ChatGPT, enabling users to utilize ChatGPT for brainstorming and refining prompts.
Stable Diffusion, which is a similar open-source diffusion model released by Stability AI, includes Stable Video Diffusion for video generation and Stable Video 3D that enables creating a 3D video of an object. The source code and model weights have been made accessible to the public, enabling users to utilize and fine-tune the models as well as develop various extensions and improvements. Furthermore, this open-source approach allows for customization tailored to specific needs, such as those required in filmmaking workflows. Numerous additional tools have been developed based on Stable Diffusion models, including GUI tools such as Stable Diffusion WebUI or ComfyUI, which offer user-friendly interfaces for designing and executing Stable Diffusion pipelines. ComfyUI gives great flexibility by using a graph/nodes/flowchart-based approach. These tools have fostered the integration of various additional features like inpainting, super resolution, and many generation guidance techniques, enabling users to exert greater control over the generation of images or videos.
Runway is a tool that enables AI video generation. A latent video diffusion model generates novel videos based on provided structural information and content information. Structural consistency is maintained by conditioning on depth estimates, while content is governed by images or natural language prompts. The Runway tool enables users to incorporate horizontal and vertical motion, camera roll, and zoom effects into their animations, thereby enriching the cinematic experience. Runway also provides a motion brush to add movement to specific areas of the animated scene.
Leonardo.ai offers image and video generation with text or image input, real-time canvas editing, 3D texture generation, one-click video asset creation, custom model training, and the ability to use negative prompts to guide the generation process.
Pika is a free AI tool that can generate videos both based on text or image prompts.
OpenAI's Sora, a new state-of-the-art diffusion model utilizing a transformer architecture, can generate videos up to a minute long while maintaining visual quality and adherence to the user's prompt. Sora is not publicly available yet, but OpenAI has given access to a select group of professional artists and filmmakers to see what they could create.
Viggle is an AI engine that automates the creation of 3D character videos. Viggle offers options for text-to-character, text-to-motion animation, and generates character animations based on an input image of the character and a guiding motion video.

However, the existing tools remain incapable, ineffective, or otherwise have limitations for overcoming the key challenges in current AI video generation of consistency, directability, and scalability, as well as issues with human actions and interactions.

### 3. The Challenge of Directability

The concept of “directability” in filmmaking refers to the control and precision a director has over various elements of the film, such as pacing, visual style, tone, camera angles, and actor performances. While advanced AI tools, such as Sora and Kling, can be useful for rapidly generating video content, the existing tools often lack the nuanced control for high quality filmmaking, where creative flexibility, originality, and real-time decision making are essential. With regard to creative control, existing AI tools typically offer pre-built templates and automated processes, which can limit a filmmaker's forms of artistic expression, their ability to achieve a specific artistic vision, and the ability to convey subtle narrative nuances in storytelling. In addition, filmmaking often requires on-the-fly decisions and adjustments based on the flow of the narrative or the performance of actors. However, the probabilistic nature of predetermined AI algorithms often hinders the real-time adjustments that are crucial for capturing the desired emotion impact or story arcs.

Camera control is another crucial element in storytelling that also presents a significant challenge when using AI tools for filmmaking. The inability to precisely manipulate camera movements, angles, and compositions can limit the director's ability to fully realize their vision, ultimately impacting the quality and effectiveness of the film. The existing AI tools struggle to replicate complex camera techniques like tracking shots, dolly zooms, or handheld camera work, which are vital for conveying complex emotions, tension, or other narrative elements. The current AI tools are typically not sophisticated enough to replicate these techniques accurately, leading to a loss of the intended impact or nuance in the film. In addition, AI filmmakers are usually confined to generic or preset camera setups, limiting their ability to tailor visual storytelling to specific narrative needs. Furthermore, certain complex sequences, such as action scenes, often require intricate camera choreography, including rapid cuts, varied angles, and precise timing, which the current AI tools have considerable difficulty executing effectively and with the necessary level of precision, resulting in scenes that are less impactful or visually coherent.

The AI filmmaking workflow platform described herein addresses these limitations by introducing a modular approach to AI filmmaking, which breaks down the production process into distinct components, each managed by specialized AI models. This approach allows for granular control over narrative flow, visual style, and camera work, aligning more closely with traditional filmmaking practices.

The AI filmmaking framework of the present disclosure enhances creative control by offering customizable AI models for different aspects of production, such as character animation, background generation, and scene composition. LoRA models can be used to digitize the actors and 3D scene reconstruction can be used to digitize the background environment. This flexibility enables more nuanced storytelling and artistic expression compared to rigid, template-based approaches. The AI filmmaking workflow platform incorporates real-time adjustment capabilities, allowing directors to modify scenes dynamically based on narrative progression or actor performances. This feature provides the responsiveness necessary for capturing the evolving emotional landscape of a film.

One key feature of the AI filmmaking workflow is its integration of virtual camera systems within a digitized 3D environment. By reconstructing scenes in 3D, directors can precisely position and move virtual cameras, enabling complex camera techniques and maintaining narrative coherence in intricate sequences. To ensure consistency in long-form content, The AI filmmaking workflow segments scenes into manageable units and uses specialized AI models to maintain visual and narrative continuity. This approach mitigates the memory limitations of traditional diffusion-based video models, allowing for the generation of longer, more coherent sequences.

By addressing these core challenges, the AI filmmaking workflow platform of this application enhances the directability of AI-assisted filmmaking and paves the way for sophisticated, high-quality productions that can rival traditional filmmaking techniques.

### 4. Digitization for Collaborative Networks

By digitizing all 3D elements, such as human characters and backgrounds, filmmakers can overcome many of the camera control limitations associated with AI tools. This digital approach provides greater flexibility, precision, and creativity in camera work, enabling complex and innovative visual storytelling techniques. It also enhances collaboration between AI and human filmmakers, improving the overall quality and impact of the film.

The current AI tools often struggle with maintaining consistency across different scenes, especially when multiple artists are involved. Each artist typically focuses on individual scene production, but ensuring the same actor appearances or environmental consistency across scenes can be problematic. This often results in a linear, waiting-dependent workflow where artists must see previous scenes to maintain coherence, significantly slowing down the production process.

In a fully digital 3D environment, virtual cameras can be positioned anywhere within the scene, giving filmmakers complete freedom to experiment with camera angles, movements, and framing. Unlike physical cameras, virtual cameras are not limited by space, allowing for more creative and intricate shots. Digital environments allow for highly precise and smooth camera movements that can be easily adjusted or animated. This enables directors or AI tools to create dynamic and fluid shots that might be difficult or impossible to achieve with traditional filming techniques. In a digital setting, changes to camera angles, lighting, or object positioning can be previewed and adjusted in real-time, allowing filmmakers to experiment and refine shots without the time and expense of reshooting in the real world.

Digital 3D environments also make it possible to create complex and innovative camera techniques that would be challenging or impossible in the physical world. For instance, cameras can seamlessly transition through walls, change perspectives, or follow action in ways that defy physical constraints. Action sequences, which often require intricate camera choreography, can be precisely controlled in a digital environment, ensuring that every movement is captured perfectly. This precision extends to special effects, where the camera can interact with CGI elements in a highly controlled manner.

In a 3D digital environment, camera settings such as focal length, depth of field, and lighting can be consistently maintained across different scenes, ensuring continuity in visual style and quality, which can be difficult to achieve with traditional cameras, especially when filming in multiple locations or at different times.

With all elements digitized, AI tools can analyze the 3D environment to suggest or automatically generate camera movements that enhance the storytelling. The AI can optimize shots based on scene composition, character movement, and lighting, resulting in a more cohesive and visually compelling film. Filmmakers can also program specific camera behaviors into the AI, such as focusing on the protagonist during emotional moments or maintaining a wide shot during action sequences. These predefined behaviors help ensure that the AI's decisions align with the director's vision.

Digitizing 3D elements also removes physical constraints such as location accessibility, lighting conditions, or equipment limitations, allowing for the creation of scenes that would be logistically challenging or prohibitively expensive to shoot in the real world.

### 5. AI-Assisted Filmmaking Framework

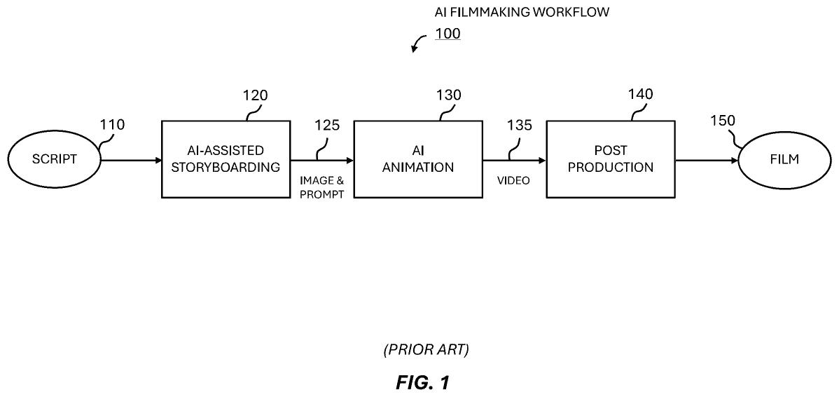

FIG. 1 is an algorithmic diagram that illustrates an AI filmmaking workflow 100 that is representative of the current state-of-the-art, detailing three main steps of the process from script input to final film output. Once a script 110 is finalized, storyboarding is conducted by artists using one or more AI-assisted storyboarding tools 120 (e.g., Midjourney, DALL-E, etc.). These AI tools can help create storyboards that define key scenes, camera angles, character actions, and other essential elements of the production process. The AI analyzes the script 110 to identify important scenes, actions, dialogue, and emotions, to generate a cohesive visual flow for the story. The AI also optimizes the layout and composition of each frame, following various cinematic principles such as the rule of thirds, depth of field, and focal points. Additionally, the AI helps position characters within the frame, suggest their actions, and simulate movements based on the script or predefined behavior models. The AI also suggests camera angles and movements, determining the best placement, motion, and perspective to capture the action. The director then reviews and approves these storyboards before production begins.

A key step in storyboarding is breaking the script down into individual visual segments, or “shots,” that will be filmed. Each shot typically lasts a few seconds, usually less than 10 seconds. This process ensures that every moment of the script is visually represented in a way that aligns with the film's narrative and artistic vision. The AI-assisted storyboarding tools 120 can output one or more images of a storyboard and one or more prompts associated with the storyboard, also referred to herein as image/prompt 125. In the example of FIG. 1, the steps following storyboarding are executed within the context of each specific shot. Each shot begins with a 2D keyframe, often generated by AI tools (e.g., Midjourney, DALL-E, etc.). With this keyframe in place, one or more AI animation tools 130 (e.g., Luma, Runway, etc.) can animate the image into a video 135 (e.g., a short video clip), which then moves into a post-production module 140 to complete the typical AI video generation process. Upon completion of the post-production process, a film 150 is output from the post-production module 140.

However, as noted above, there are several challenges facing today's advanced AI filmmaking tools, such as maintaining consistency in generated characters and backgrounds, controlling camera movements, and creating animations with complex character interactions or dynamic motions. To address these issues in the rapidly evolving field of AI-assisted filmmaking, the present disclosure provides a new AI-assisted filmmaking framework that combines four key technological approaches into a cohesive AI filmmaking process:
(1) Digitize Everything in the 3D Scene: This process involves converting one or a set of 2D image(s) or video(s), whether captured from the physical world or generated by AI, into a 3D digital space-a concept often seen in animated film production. However, the purpose and technology used here are quite different. In traditional animated filmmaking, every object and detail must be meticulously crafted, making 3D modeling a costly task. In the new AI-assisted filmmaking framework described herein, however, the emphasis is on capturing the 3D structure of scenes, objects, and layouts. The main goal is to provide AI with workflow guidance through depth maps or edge maps, enabling precise camera control settings when generating images and videos. As a result, digitization can be achieved at a relatively low-cost using methods like Gaussian splatting or monocular depth estimation, or by reusing or revising existing 3D models. On the other hand, by using LoRA models, the human faces can maintain consistency across various shots.
(2) Digitize Humans Through 2D Camera Capture: This technique is similar to what is used in live-action filmmaking, where actors perform in front of a green screen. By recording their facial expressions and body movements, the captured data can either replace AI-generated faces with more realistic human features or be used to map the actor's movements onto an AI-generated character through style transfer. This resolves the challenges AI is currently facing in mimicking complex physical character interactions and representing human emotions.
(3) Better Controlled AI Animation: To address consistency and camera control issues, the enhanced AI animation process utilizes multiple prompts from the digitization processes to animate the keyframe more effectively. These prompts provide guidance for camera settings, storytelling, and defining the styles or attributes of specific characters or background elements. By integrating these diverse prompts, filmmakers can gain greater control over the AI pipeline.
(4) AI-Assisted Compositing for Complex Scenarios: This process involves managing multiple virtual cameras simultaneously to capture elements from different spaces, like a simulated virtual environment and a recorded physical location, and seamlessly combining them into a single frame. Visual effects (or VFX) can also be used to create realistic or fantastical environments, characters, and effects that are challenging, costly, or impossible to achieve with traditional techniques.

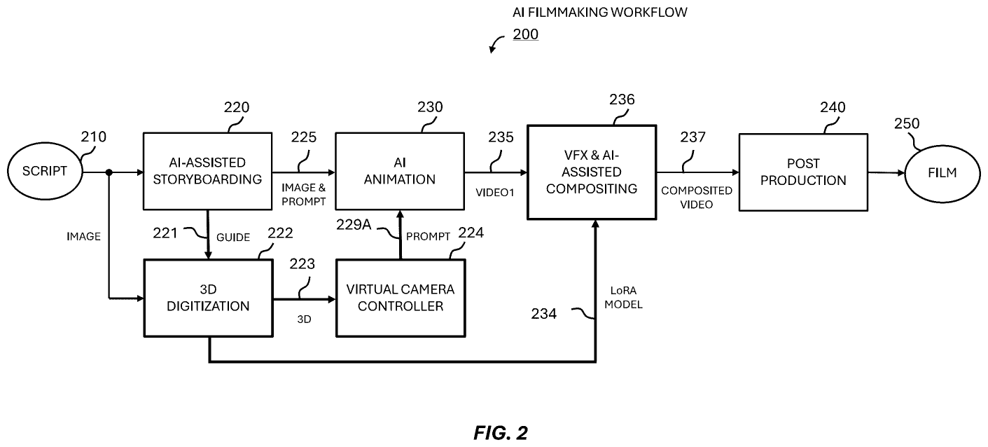

Now referring to FIGS. 2, 3, and 4, various example embodiments of the present disclosure can enhance the existing AI filmmaking process 100 shown in FIG. 1 by adding various new functionalities (represented by corresponding computer-implemented “modules” in the figures and the following description). Various operations of the methods described herein can be implemented using hardware, software, or a combination thereof, as described further below.

FIG. 2 is an algorithmic diagram that illustrates an AI filmmaking workflow 200 according to a first example embodiment of the present disclosure. In addition to an AI-assisted storyboarding module 220, an AI animation module 230, and a post-production module 240, the AI filmmaking workflow 200 of FIG. 2 also includes a 3D digitization module 221, a virtual camera controller 224, and an AI-assisted compositing module 236.

As shown in FIG. 2, the script 210 (e.g., one or more images thereof) is input to the AI-assisted storyboarding module 220. Based on the script 210 (e.g., the images thereof), the AI-assisted storyboarding module 220 outputs a guide 221 to the 3D digitization module 222, and outputs an image/prompt 225 to the AI animation module 230, respectively.

Based on the script 210 (e.g., the image(s) thereof) and the guide 221, the 3D digitization module 222 generates a 3D environment 223 (i.e., a digitized 3D scene representation, including background, foreground, objects, people, etc.), and outputs the 3D environment 223 to the virtual camera controller 224. The virtual camera controller 224 receives the 3D environment 223 (digitized 3D scene representation) as input from the 3D digitization module 222, and outputs a prompt 229A to the AI animation module 230 in connection with the 3D environment 223.

In this example embodiment, the AI animation module 230 generates a first video 235 (Video1) based not only on the image/prompt 225 received from the AI-assisted storyboarding module 220, but also based on the prompt 229A received from the virtual camera controller 224 in connection with the 3D environment 223. The AI animation module 230 outputs the first video 235 (Video1) to the AI-assisted compositing module 236 for further processing.

Meanwhile, the 3D digitization module 222 can also generate or obtain a LoRA model 234 (i.e., a digitized 3D character representation) based on the script 210 and the guide 221, and output the LoRA model 234 to the AI-assisted compositing module 236 for further processing in connection with the first video 235 (Video1).

In this example embodiment, the AI-assisted compositing module 236 is configured to perform various compositing operations with respect to the first video 235 (Video1) received from the AI animation module 230 and the LoRA model 234 (digitized 3D character representation) received from the 3D digitization module 222 to generate a composited video 237. In some embodiments, the AI-assisted compositing module 236 can also enhance the composited video 237 with visual effects (VFX), sound effects (SFX), and/or various combinations thereof.

The AI-assisted compositing module 236 outputs the composited video 237 to the post-production module 240 for completion of the processing. The post-production module 240 is then used to perform one or more post-processing operations with respect to the composited video 237 received from the AI-assisted compositing module 236 to generate the film 250.

According to the example embodiment of FIG. 2, the film 250 (i.e., the final version of the video, or an extended film clip) produced by the AI filmmaking workflow 200 has various enhancements that are enabled by the addition of the 3D digitization module 222, the virtual camera controller 224, and the AI-assisted compositing module 236, respectively. The 3D digitization module 222 converts various elements into 3D environments 223 (digitized 3D scene representations) using cost-effective methods, allowing the virtual camera controller 224 to adjust camera settings dynamically in a 3D space. The AI animation module 230 receives multiple prompts to effectively animate keyframes. These prompts can include narrative input from the AI-assisted storyboarding module 220 (e.g., image/prompt 225), as well as camera settings from the virtual camera controller module 224 (i.e., prompt 229A) in this example embodiment.

The integration of these diverse inputs significantly enhances filmmakers' control over the AI pipeline, marking a key innovation of the new framework described herein. Additionally, FIG. 2 demonstrates how the AI-assisted compositing module 236 blends visual elements from various sources into different depth layers within a single frame or sequence. This includes videos generated by the AI animation module 230 and elements created using LoRA models 234 (digitized 3D character representations) from the 3D digitization process in this example embodiment.

Therefore, the new framework provided by the AI filmmaking workflow 200 of FIG. 2 introduces the following capabilities for directors and artists: (1) allowing directors to determine camera angles and movements for each shot by using depth maps from virtual cameras within a digitized 3D space, enabled by the 3D digitization module 222 and the virtual camera controller module 224; and (2) ensuring consistency of human characters and backgrounds across multiple shots, achieved by the LoRA model 234, which is trained using data from the 3D digitization process. This allows objects to be consistently regenerated and integrated into scenes through the AI-assisted compositing module 236.

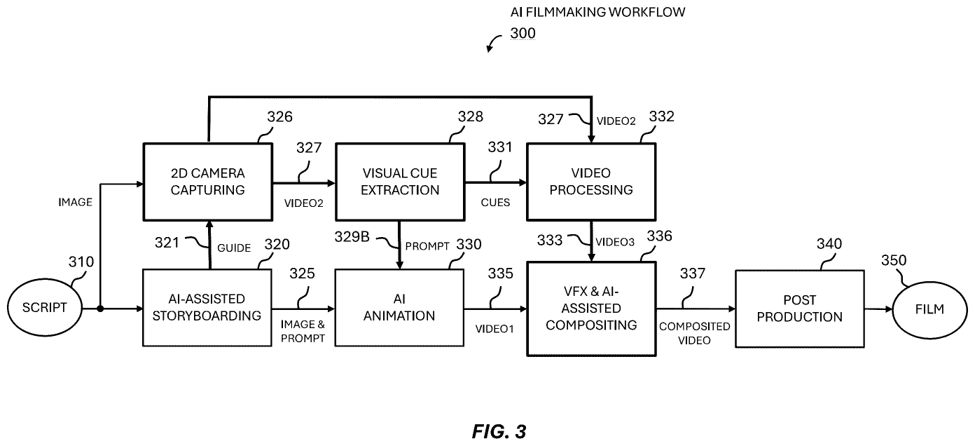

However, when the 3D digitization module 222, the virtual camera controller module 224, and the AI animation tool 230 as described above with reference to FIG. 2 cannot meet a director's specific needs, such as for complex human behavior or interactions, a 2D camera capture module can be used, as described further below with reference to FIG. 3. In some example embodiments, this 2D camera capture module can be used in addition to the 3D digitization module 222. However, it should be appreciated that the 2D camera capture module can be used as an alternative to the 3D digitization module 222 in other example embodiments, depending on needs of the director and the suitability for the 3D digitization mode described above or the 2D camera capture mode described below for obtaining the desired results.

FIG. 3 is an algorithmic diagram that illustrates an AI filmmaking workflow 300 according to a second example embodiment of the present disclosure. In addition to an AI-assisted storyboarding module 320, an AI animation module 330, and a post-production module 340, the AI filmmaking workflow 300 of FIG. 3 also includes a 2D camera capturing module 326, a visual cue extraction module 328, a video processing module 332, and an AI-assisted compositing module 336.

As shown in FIG. 3, the script 310 (e.g., one or more images thereof) is input to the AI-assisted storyboarding module 320. Based on the script 310 (e.g., the images thereof), the AI-assisted storyboarding module 320 outputs a guide 321 to the 2D camera capturing module 326, and outputs an image/prompt 325 to the AI animation module 330, respectively.

Based on the script 310 (e.g., the image(s) thereof) and the guide 321, the 2D camera capturing module 326 generates a second video 327 (Video2), and outputs the second video 327 to the visual cue extraction module 328. The visual cue extraction module 328 receives the second video 327 (Video2) as input from the 2D camera capturing module 326, and outputs a prompt 329B to the AI animation module 330 in connection with the second video 327.

In this example embodiment, the AI animation module 330 generates a first video 335 (Video1) based not only on the image/prompt 325 received from the AI-assisted storyboarding module 320, but also based on the prompt 329B received from the visual cue extraction module 328 in connection with the second video 327 (Video2). The AI animation module 330 outputs the first video 335 (Video1) to the AI-assisted compositing module 336 for further processing.

Meanwhile, the visual cue extraction module 328 can also generate cues 331 based on the second video 327 (Video2) received from the 2D camera capturing module 326, and output the cues 331 to the video processing module 332. The video processing module 332 receives the second video 327 (Video2) from the 2D camera capturing module 326 and the cues 331 from the visual cue extraction module 328 as input, and generates a third video 333 (Video3) based on the second video 327 (Video2) and the cues 331. The video processing module 332 outputs the third video (Video3) to the AI-assisted compositing module 336 for further processing in connection with the first video 335 (Video1).

In this example embodiment, the AI-assisted compositing module 336 is configured to perform various compositing operations with respect to the first video 335 (Video1) received from the AI animation module 330 and the third video 333 (Video3) received from the video processing module 332 to generate a composited video 337. In some embodiments, the AI-assisted compositing module 336 can also enhance the composited video 337 with visual effects (VFX), sound effects (SFX), and/or various combinations thereof.

The AI-assisted compositing module 336 outputs the composited video 337 to the post-production module 340 for completion of the processing. The post-production module 340 is then used to perform one or more post-processing operations with respect to the composited video 337 received from the AI-assisted compositing module 336 to generate the film 350.

According to the example embodiment of FIG. 3, the film 350 (i.e., the final version of a video, or an extended film clip) produced by the AI filmmaking workflow 300 has various enhancements that are enabled by the addition of the 2D camera capturing module 326, the visual cue extraction module 328, the video processing module 332, and the AI-assisted compositing module 336, respectively. The visual cue extraction module 328 extracts visual cues-such as human poses, skeletal movements, and facial expressions—from captured images or videos to assist the AI animation module 330. The AI animation module 330 receives multiple prompts to effectively animate keyframes. These prompts can include narrative input from the AI-assisted storyboarding module 320 (e.g., image/prompt 325), as well as style or attribute definitions for specific characters or background elements from the visual cue extraction module 328 (i.e., prompt 329B) in this example embodiment.

The integration of these diverse inputs significantly enhances filmmakers' control over the AI pipeline, marking a key innovation of the new framework described herein. Additionally, FIG. 3 demonstrates how the AI-assisted compositing module 336 blends visual elements from various sources into different depth layers within a single frame or sequence. This includes videos generated by the AI animation module 330 and components processed by the video processing module 332 from the 2D camera capturing module 326 in this example embodiment.

Therefore, the new framework provided by the AI filmmaking workflow 300 of FIG. 3 introduces the following capabilities for directors and artists: (1) enabling directors to modify a character's face, costume, hairstyle, pose, and movement through prompts, supported by the visual cue extraction module 328 that feeds into the AI animation module 330; and (2) allowing directors to capture human performances or interactions that cannot be synthesized by AI using the 2D camera capturing module 326, which are then seamlessly integrated into the digital space using the visual cue extraction module 328, the video processing module 332, and the AI-assisted compositing module 336, respectively.

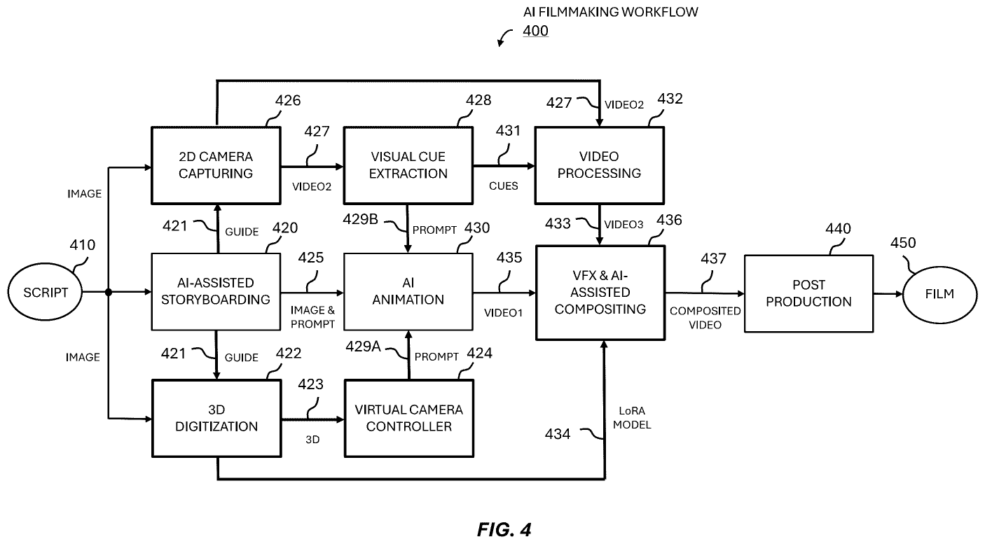

Further, the example embodiments of the present disclosure are not limited to only one of the two distinct solutions described above with reference to FIG. 2 and FIG. 3, respectively. In order to even better satisfy directors' needs, various aspects from both the AI filmmaking workflow 200 of FIG. 2 and the AI filmmaking workflow 300 of FIG. 3 can be integrated together and functionalities and techniques described above can be combined in various ways as described further below with reference to FIG. 4, thereby providing a more comprehensive solution to the aforementioned problems in comparison to using only one of the above embodiments individually.

FIG. 4 is an algorithmic diagram that illustrates an AI filmmaking workflow 400 according to a third example embodiment of the present disclosure. In addition to an AI-assisted storyboarding module 420, an AI animation module 430, and a post-production module 440, the AI filmmaking workflow 400 of FIG. 4 also includes a 3D digitization module 422, a virtual camera controller 424, a 2D camera capturing module 426, a visual cue extraction module 428, a video processing module 432, and an AI-assisted compositing module 436.

As shown in FIG. 4, the script 410 (e.g., one or more images thereof) is input to the AI-assisted storyboarding module 420. Based on the script 410 (e.g., the images thereof), the AI-assisted storyboarding module 420 outputs a guide 421 to the 3D digitization module 422, and outputs an image/prompt 425 to the AI animation module 430, respectively.

Based on the script 410 (e.g., the image(s) thereof) and the guide 421, the 3D digitization module 422 generates a 3D environment 423 (i.e., a digitized 3D scene representation, including background, foreground, objects, people, etc.), and outputs the 3D environment 423 to the virtual camera controller 424. The virtual camera controller 424 receives the 3D environment 423 (digitized 3D scene representation) as input from the 3D digitization module 422, and outputs a prompt 429A to the AI animation module 430 in connection with the 3D environment 423.

The AI animation module 430 generates a first video 435 (Video1) based not only on the image/prompt 425 received from the AI-assisted storyboarding module 420, but also based on the prompt 429A received from the virtual camera controller 424 in connection with the 3D environment 423. The AI animation module 430 outputs the first video 435 (Video1) to the AI-assisted compositing module 436 for further processing.

Meanwhile, the 3D digitization module 422 can also generate or obtain a LoRA model 434 (i.e., a digitized 3D character representation) based on the script 410 and the guide 421, and output the LoRA model 434 to the AI-assisted compositing module 436 for further processing in connection with the first video 435 (Video1).

In this example, the AI-assisted compositing module 436 is configured to perform various compositing operations with respect to the first video 435 (Video1) received from the AI animation module 430 and the LoRA model 434 (digitized 3D character representation) received from the 3D digitization module 422 to generate a composited video 437. The AI-assisted compositing module 436 can also enhance the composited video 437 with visual effects (VFX), sound effects (SFX), and/or various combinations thereof.

However, in a situation where the 3D digitization module 422, the virtual camera controller module 424, and the AI animation tool 430 (as described above with reference to FIG. 2) does not adequately meet a director's specific needs, such as for complex human behavior or interactions, a 2D camera capture module can be used (as described above with reference to FIG. 3). In some example embodiments, this 2D camera capture module can be used in addition to the 3D digitization module 422. Again, it should be appreciated that the 2D camera capture module can be used as an alternative to the 3D digitization module 422 in other example embodiments, depending on needs of the director and the suitability for the 3D digitization mode described above or the 2D camera capture mode described below for obtaining the desired results.

Thus, in some additional or alternative example embodiments, the AI-assisted storyboarding module 420 outputs the guide 421 to the 2D camera capturing module 426, and outputs the image/prompt 425A to the AI animation module 430, respectively. Based on the script 410 (e.g., the image(s) thereof) and the guide 421, the 2D camera capturing module 426 generates a second video 427 (Video2), and outputs the second video 427 to the visual cue extraction module 428. The visual cue extraction module 428 receives the second video 427 (Video2) as input from the 2D camera capturing module 426, and outputs a prompt 429B to the AI animation module 430 in connection with the second video 427 (Video2).

In this example embodiment, the AI animation module 430 generates a first video 435 (Video1) based not only on the image/prompt 425 received from the AI-assisted storyboarding module 420, but also based on the prompt 429B received from the visual cue extraction module 428 in connection with the second video 427 (Video2). The AI animation module 430 outputs the first video 435 (Video1) to the AI-assisted compositing module 436 for further processing.

Meanwhile, the visual cue extraction module 428 can also generate cues 431 based on the second video 427 (Video2) received from the 2D camera capturing module 426, and output the cues 431 to the video processing module 432. The video processing module 432 receives the second video 427 (Video2) from the 2D camera capturing module 426 and the cues 431 from the visual cue extraction module 428 as input, and generates a third video 433 (Video3) based on the second video 427 (Video2) and the cues 431. The video processing module 432 outputs the third video (Video3) to the AI-assisted compositing module 436 for further processing in connection with the first video 435 (Video1).

In this additional or alternative example, the AI-assisted compositing module 436 is configured to perform various compositing operations with respect to the first video 435 (Video1) received from the AI animation module 430 and the third video 433 (Video3) received from the video processing module 432 to generate a composited video 437. In some embodiments, the AI-assisted compositing module 436 can also enhance the composited video 437 with visual effects (VFX), sound effects (SFX), and/or various combinations thereof.

In either of the above example embodiments, the AI-assisted compositing module 436 outputs the composited video 437 to the post-production module 440 for completion of the processing. The post-production module 440 is then used to perform one or more post-processing operations with respect to the composited video 437 received from the AI-assisted compositing module 436 to generate the film 450 (i.e., the final version of the video, or an extended film clip).

According to the example embodiments of FIG. 4, the film 450 produced by the AI filmmaking workflow 400 has various enhancements that are enabled by the addition of the 3D digitization module 422, the virtual camera controller 424, and the AI-assisted compositing module 436, respectively; and/or by the addition of the 2D camera capturing module 426, the visual cue extraction module 428, the video processing module 432, and the AI-assisted compositing module 436, respectively.

In particular, the 3D digitization module 422 converts various elements into 3D environments 423 (digitized 3D scene representations) using cost-effective methods, allowing the virtual camera controller 424 to adjust camera settings dynamically in a 3D space. Additionally or alternatively, the visual cue extraction module 428 extracts visual cues-such as human poses, skeletal movements, and facial expressions—from captured images or videos to assist the AI animation module 430. The AI animation module 430 receives multiple prompts to effectively animate keyframes. These prompts can include narrative input from the AI-assisted storyboarding module 420 (e.g., image/prompt 425) and camera settings from the virtual camera controller module 424 (i.e., prompt 429A), as well as style or attribute definitions for specific characters or background elements from the visual cue extraction module 428 (i.e., prompt 429B).

As noted, the integration of these diverse inputs significantly enhances filmmakers' control over the AI pipeline, marking a key innovation of the new framework described herein. Additionally, FIG. 4 demonstrates how the AI-assisted compositing module 436 blends visual elements from various sources into different depth layers within a single frame or sequence. This can include videos generated by the AI animation module 430, elements created using LoRA models 434 (digitized 3D character representations) from the 3D digitization process, and/or components processed by the video processing module 432 from the 2D camera capturing module 426.

Therefore, the new framework provided by the AI filmmaking workflow 400 of FIG. 4 introduces the following capabilities for directors and artists:
Allowing directors to determine camera angles and movements for each shot by using depth maps from virtual cameras within a digitized 3D space, enabled by the 3D digitization module 422 and the virtual camera controller module 424;
Enabling directors to modify a character's face, costume, hairstyle, pose, and movement through prompts, supported by the visual cue extraction module 428 that feeds into the AI animation module 430;
Ensuring consistency of human characters and backgrounds across multiple shots, achieved by the LoRA model 434, which is trained using data from the 3D digitization process, thereby allowing objects to be consistently regenerated and integrated into scenes through the AI-assisted compositing module 436; and
Allowing directors to capture human performances or interactions that cannot be synthesized by AI using the 2D camera capturing module 426, which are then seamlessly integrated into the digital space using the visual cue extraction module 428, the video processing module 432, and the AI-assisted compositing module 436, respectively.

Accordingly, the AI filmmaking workflow 400 of FIG. 4 can even better satisfy directors' needs by integrating together various aspects from both the AI filmmaking workflow 200 of FIG. 2 and the AI filmmaking workflow 300 of FIG. 3, respectively, such that the corresponding functionalities and techniques described above can be combined in various ways to provide a more comprehensive solution to address the aforementioned problems associated with existing AI filmmaking workflows and tools.

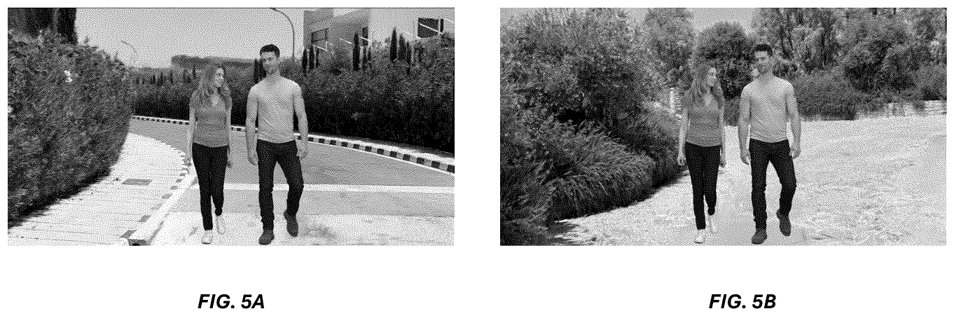

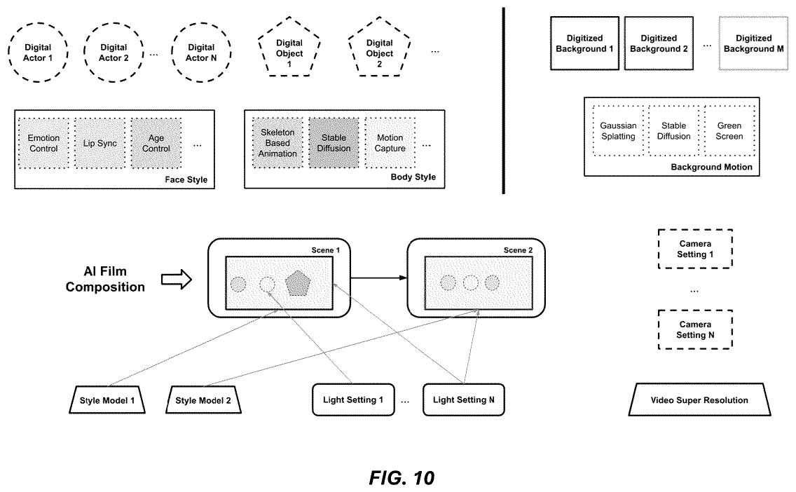

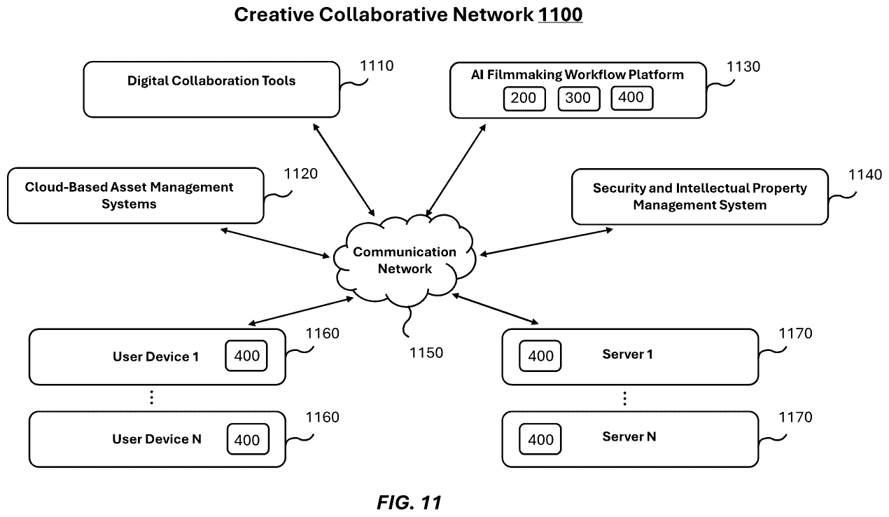

Next, certain aspects of the above-described AI filmmaking workflows of FIGS. 2, 3, and 4 will be explained with reference to FIGS. 5A-5B, FIGS. 6A-6D, FIGS. 7A-7B, FIGS. 8A-8B, FIGS. 9A-9C, respectively. Then, the use of these AI-assisted digitization techniques to implement collaborative networks will be described with reference to FIG. 10 and FIG. 11.

### 5.1 Digitization

Digitizing a 3D space, particularly when dealing with complex backgrounds, is a challenging task. However, to achieve the necessary flexibility in camera control, it remains the most effective approach if a cost-efficient solution is available. For most scenarios when a person can be physically present, Gaussian splatting technology can be used to reconstruct a 3D background model from a sequence of images captured on-site, as shown in FIGS. 5A-5B.

FIG. 5A and FIG. 5B respectively show images in which the backgrounds were created using Gaussian splatting, with the same human elements added into the 3D space afterward, allowing for flexible camera control within the 3D scene.

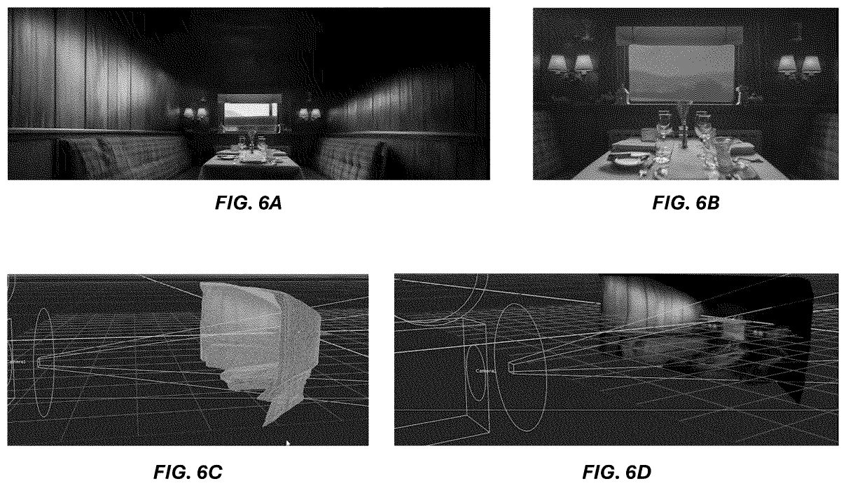

In situations where it is not possible for the person to be physically present, however, monocular depth estimation can be employed to predict the depth of various points in a 2D image, as shown in FIGS. 6A-6D, which can be an image captured by a camera or an AI generated 2D image. By training on large datasets with corresponding depth maps, this method allows for a reasonable “2.5D” reconstruction, particularly in confined spaces such as indoors.

FIGS. 6A-6D demonstrate creating a 2.5D image from a 2D image using monocular depth estimation, according to an example embodiment. FIG. 6A is a 2D image before processing. FIG. 6B is a regenerated 2D image from a different camera setting. FIG. 6C illustrates a reconstructed 3D depth model under camera control. FIG. 6D illustrates a reconstructed 3D space under camera control.

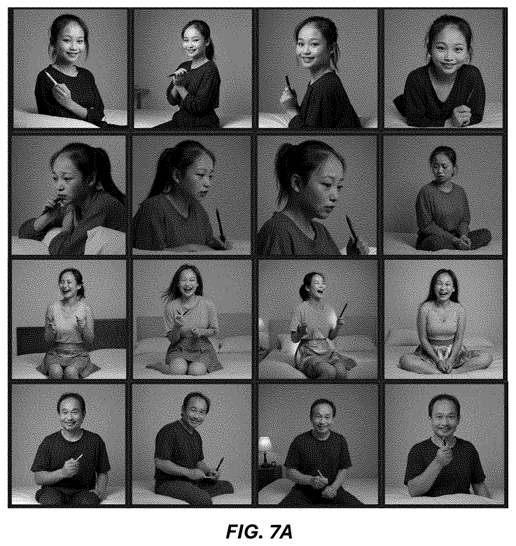

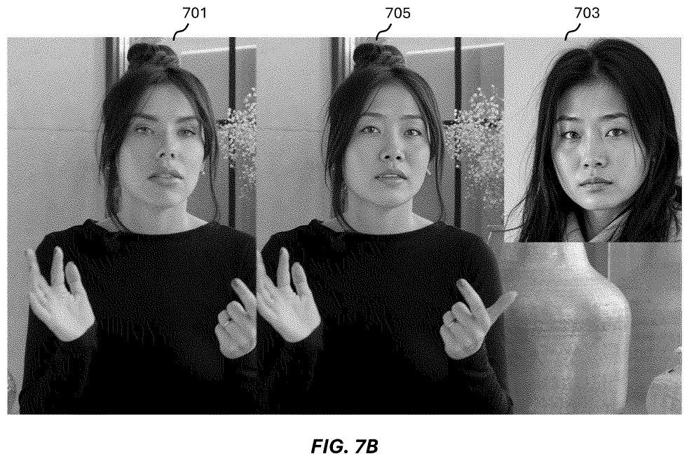

During the digitization process, human faces are scanned in 3D from various angles and with different expressions. These scans are converted into specialized models to ensure consistent appearances across shots. In particular, Low-Rank Adaption (LoRA) models (e.g., refer to 234, 434) are fine-tuned to capture distinct character features and expressions. By using low-rank decomposition to adjust the weights of pre-trained models, LoRA allows adaptation to different scene conditions while maintaining visual continuity throughout the film. This approach preserves facial features and expressions consistently without requiring full network retraining. FIGS. 7A and 7B are each examples that illustrate digitizing human appearances to demonstrate this capability.

FIG. 7A shows images arranged in rows and columns that are generated by a LoRA model, such as the LoRA model 234 of FIG. 2 or the LoRA model 434 of FIG. 4. In the example of FIG. 7A, a single LoRA model generates four rows of faces-showing a smiling face at age 10, a sad face at age 15, a laughing face at age 40, and a smiling male face at age 50 with a different gender. FIG. 7A demonstrates the LoRA model's ability to maintain character consistency. With the LoRA model, the user can adjust the age, gender, hairstyle, clothing, facial expression, and so on to customize the generated character, as shown in FIG. 7A.

FIG. 7B shows a set of images to demonstrate how using a LoRA model can replace a human character's face with a digitized 3D model, while retaining the original action and expression. In the example of FIG. 7B, the left panel 701 shows the original frame (a portrait of a first person), the right panel 703 shows the face (a face of a second person) to be applied by the LoRA model, and the middle panel 705 shows a modified version of the original frame with the LoRA model face replacement integrated therein. Thus, the LoRA model can be used to replace the face of the first person with the face of the second person that is different from the first person, while otherwise maintaining the consistency of appearance overall.

### 5.2 Style Transfer

When human actions in the AI-generated scenes fail to satisfy the director's vision, the AI filmmaking workflow platform offers a hybrid approach that leverages human performances to guide and refine AI-generated content. The platform implements a strategy that combines human performance capture with AI-assisted refinement.

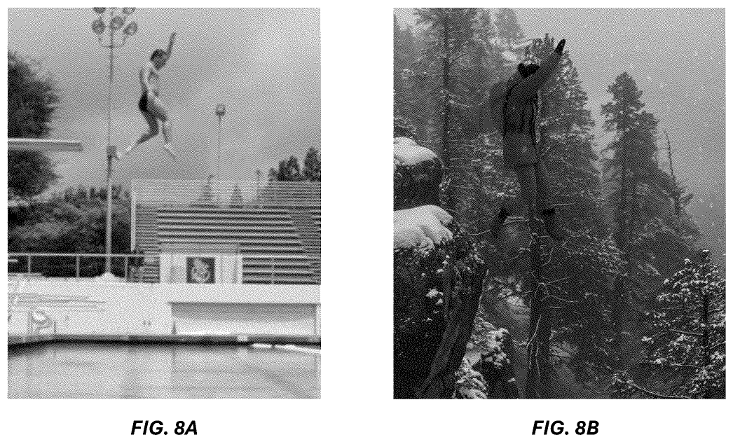

If the director is not satisfied with the human actions or activities generated by the AI tools, an effective alternative is to have an actor or multiple actors perform the desired actions as a reference. These performances are recorded, capturing precise poses and movements that serve as a blueprint for AI content generation. The recorded poses and movements can then be used to guide the AI in replicating these actions, as illustrated in FIGS. 8A-8B. This technique allows for more nuanced and director-specific action sequences.

FIGS. 8A-8B demonstrate a motion guide prompt extracted from the camera captured performance. FIG. 8A shows a live actor performance, and FIG. 8B shows an AI-generated character using the same style of movements as the live actor.

By using the recorded human performances as a foundation, the AI tools can then reconstruct and refine the scene. This process allows for the integration of the director's specific vision with the capabilities of AI generation. Furthermore, this framework also enables the enhancement of various details to improve the director's control. For example, details such as facial expressions, costumes, hairstyles, and other elements can be refined and provided as prompts to enhance directability for the director. Captured facial expressions from actors can be used to guide the AI in generating more authentic and emotionally resonant performances. Specific costume and hairstyle designs can be provided as prompts to ensure the AI generates characters with the exact look envisioned by the director. Additionally, real-world references can be used to fine-tune AI-generated backgrounds and props.

### 5.3 Camera Control

As outlined above, the digitization process involves reconstructing a 3D model (or 2.5D model) of the environment, and this model can be derived from various sources, including from 2D AI-generated images, 2D camera captures, or 3D camera scans. FIG. 2 and FIG. 4 provide a visual representation of how the 3D digitization module creates a comprehensive 3D scene representation, which is subsequently utilized in the camera control phase. Within this 3D space, a “virtual camera” (as depicted in FIG. 6D) can simulate views from any position. These simulated views, along with their corresponding depth maps or edge maps, are then fed into the AI tools described above, enabling the AI-assisted generation of video content that precisely aligns with the intended camera settings.

While some stable diffusion-based short video generation tools offer the ability to incorporate camera movement as a text condition or provide pre-trained camera movement LoRA models, these approaches often have significant limitations. The reproducibility of continuous movement poses a considerable challenge, and attempts to create new shots of the same scene from different angles frequently result in inconsistent details being added or removed. Resampling the random number seed until generating satisfactory results is a time-consuming process requiring numerous iterations.

In contrast, the models of the present disclosure leverage Gaussian splatting to reconstruct the 3D background, offering a distinct advantage. This approach allows for a consistent background representation while providing unrestricted camera movement capabilities. By utilizing this 3D reconstruction technique, the limitations of existing AI tools in maintaining scene consistency across different camera angles and movements can be overcome. This not only enhances the flexibility of shot composition but also significantly reduces the time and computational resources required to achieve desired results. Thus, the AI filmmaking framework described herein can bridge the gap between the creative freedom desired by filmmakers and the technical limitations of current AI-based video generation tools, offering a more robust and efficient solution for dynamic, multi-angle scene creation in AI-assisted filmmaking.

### 5.4 AI-Assisted Compositing

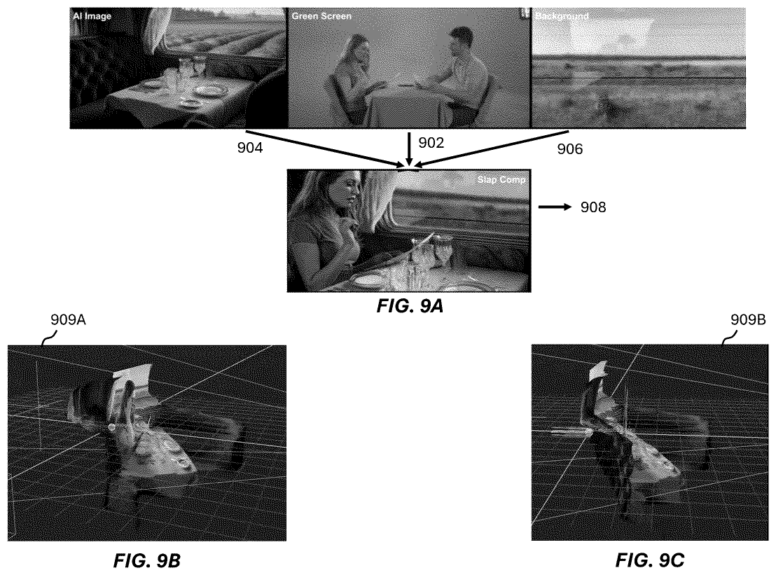

If the director is dissatisfied with certain elements of the AI-generated video shot at any point in the filmmaking process, the AI-assisted compositing module provides another solution. The AI-assisted compositing module enables the replacement of foreground objects or background objects and the application of style transfers to enhance both. For instance, if the AI-generated characters' movements lack realism, the AI-assisted compositing module can integrate the performances of real actors into the scene, as shown in FIGS. 9A-9C.

FIGS. 9A-9C demonstrate a scenario when a director decides to composite the performance of real actors (green screen 902), a stable background (AI image 904), and moving window scenes (background 906) into a single frame (slap comp 908), according to an aspect of the present disclosure. FIG. 9A shows multiple layers of objects (902, 904, 906) to be composited into one frame (908). FIG. 9B shows a first viewing angle 909A of the compositing process with multiple layers of objects composited into one frame (908), and FIG. 9C shows a second viewing angle 909B of the compositing process with multiple layers of objects composited into one frame (908).

Thus, a typical compositing process according to the example embodiments of the present disclosure blends multiple visual elements-such as videos, images, and graphics-into a single cohesive frame or sequence. As described above with reference to FIG. 2, FIG. 3, and FIG. 4, various input sources to the AI-assisted compositing module can include any of the following: (1) one or multiple videos (in various depth layers) generated from the AI animation process, supported by the 3D digitization module and the virtual camera controller module (refer to FIG. 2 and FIG. 4); (2) footage captured by 2D cameras, processed through the visual cue extraction module and the video processing module to create alpha channels and masks for visible objects to be integrated into the scene (refer to FIG. 3 and FIG. 4); (3) 3D characters created by the 3D digitization module (refer to FIG. 2 and FIG. 4); and/or (4) graphical elements generated by the VFX process (refer to any of FIGS. 2, 3, 4).

According to the example embodiments described above, the AI-assisted compositing module synchronizes multiple or all of these elements with a master camera (such as the camera used by the 2D camera capturing module) to ensure that virtual backgrounds, newly created 3D characters, and visual effects are seamlessly integrated with the live-action footage when producing the composited video.

### 5.5. Post-Production

The transformation of AI-generated footage (e.g., 237, 337, 437) into cinema-quality film (e.g., 250, 350, 450) requires extensive post-processing. The current limitations of AI models, which typically generate short-duration video clips, often result in inconsistencies in style, lighting, and resolution between these segments. While the AI filmmaking framework successfully addresses overall coherence and narrative continuity, achieving uniform style, composition, and lighting across the entire production remains a formidable challenge.

To address stylistic discrepancies between scenes, recent advancements in video style transfer have shown promising results. These techniques allow for the application of a consistent style across an entire video based on a few stylized keyframes. This approach enables filmmakers to maintain a cohesive visual aesthetic throughout the production process, enhancing the overall quality and artistic vision of the film.

Lighting plays a pivotal role in cinematic storytelling, but traditionally it requires labor-intensive manual adjustments using existing tools (e.g., Adobe After Effects). For instance, when an object is moved from one background to another, lighting conditions must be manually recalibrated. AI-based relighting technologies are transforming this process for still images, offering fast, automated solutions that preserve the emotional depth and realism of professional lighting while dramatically reducing production time and costs. Using the digitization framework, the AI filmmaking workflow of the present disclosure can now treat lighting as a manipulable element for video. AI can extract lighting from a background and apply it seamlessly to a foreground object. For the first time, artists can “draw” lighting onto objects as needed, achieving effects that no amount of color range or bit depth could previously allow. With these advancements, artists now have unprecedented control over the use of lighting to tell that story.

The generation of high-resolution video content poses a particular challenge for AI systems due to the extensive GPU memory requirements of models like Stable Diffusion. This limitation complicates the production of long-form 4K videos that meet industry standards. A promising workaround involves generating content at lower resolutions and subsequently applying AI-driven super-resolution techniques. These models intelligently enhance video resolution and texture detail, enabling the creation of high-quality content within the constraints of current GPU technology.

The integration of these advanced post-processing techniques into comprehensive frameworks like the AI filmmaking workflow platform of the present disclosure represents a significant step towards bridging the quality gap between AI-generated film content and traditionally produced film content, potentially transforming the landscape of modern filmmaking.

The AI filmmaking workflow platform introduces a new perspective in AI-based filmmaking by decomposing the elements of a movie and addressing them with specialized models, rather than relying on a single model to generate the entire film. This approach effectively resolves many of the challenges faced by existing models, including issues with directability, video consistency, and scalability.

### 6. Creative Collaborative Networks

### 6.1 Digitization for Collaborative Networks

As noted, the current AI tools often struggle with maintaining consistency across different scenes, especially when multiple artists are involved. Each artist typically focuses on individual scene production, but ensuring the same actor appearances or environmental consistency across scenes can be problematic. This often results in a linear, waiting-dependent workflow where artists must see previous scenes to maintain coherence, significantly slowing down the production process.

The AI filmmaking framework described herein tackles these challenges through a comprehensive digitalization approach. The process begins with the digitization of key elements, such as the environment, actors, scene styles, and lighting models. FIG. 10 depicts the overall framework for a collaborative network, as explained in further detail below. Crucially, these digitizations are independent of each other and can be executed in parallel, enabling artists to work separately. This structure also allows real actor video shots to be placed directly into the AI-based workflow. This initial setup forms the foundation for consistent, collaborative AI movie making.

Once the digitization is complete, the AI filmmaking workflow platform and collaborative network described herein allows artists to work on individual scenes or shots as requested by the director, without the need for strict sequential dependencies. The use of digitized actor LoRA models and 3D reconstructions of background environments can ensure consistency across different scenes, even when they are produced by different artists or teams. This approach significantly reduces the need for artists to wait for each other's work to maintain coherence, as the models themselves provide the necessary consistency.

FIG. 10 is a conceptual diagram that illustrates the overall structure of an AI film composition process using the AI filmmaking workflow in a collaborative network according to an aspect of the present disclosure. FIG. 10 demonstrates how different scenes (e.g., scene 1, 2, etc.) can be created that share similar actor elements (e.g., digital actors 1-N) and background elements (digitized backgrounds 1-M), while still incorporating unique objects (e.g., digital objects 1, 2, etc.) or other variations in style (e.g., face style, body style, style models 1, 2, etc.), lighting (e.g., light settings 1-N), and/or camera angles (e.g., camera settings 1-N). For example, background motion can be represented using Gaussian splatting, stable diffusion, green screen, etc.; body style can be represented using skeleton based animation, stable diffusion, motion capture, etc.; and face style can be represented using emotion control, lip sync, age control, etc. This design facilitates a truly collaborative network where, theoretically, each scene can be produced substantially in parallel, dramatically increasing efficiency and reducing production time.

As shown in FIG. 10, example embodiments of the present disclosure provide an innovative approach to AI-assisted movie production that utilizes a unique digitalization approach. The framework employs LoRA fine-tuning techniques to digitize actors, ensuring consistent character representation. Background elements are reconstructed in 3D using advanced AI models, creating fully manipulable digital versions of scenes. The framework integrates style transfer, relighting, and various post-processing models, applicable across all scenes for cohesive visual aesthetics. Once these foundational components are trained and fine-tuned, multiple artists can simultaneously utilize these digital assets to compose requested scenes. This parallel workflow facilitates a collaborative environment, significantly reducing overall film production time and enhancing creative flexibility.

Thus, by digitizing all 3D elements, such as human characters and backgrounds, filmmakers can overcome many of the camera control limitations associated with AI tools. This digital approach provides greater flexibility, precision, and creativity in camera work, enabling complex and innovative visual storytelling techniques. It also enhances collaboration between AI and human filmmakers, improving the overall quality and impact of the film.

6.2 Scaling AI Filmmaking with Collaborative Networking

Due to the current limitations of AI technology, traditional 2D camera work with real actors and remote support for 3D digitization of specific landscapes or outdoor scenes will remain valuable. Meanwhile, AI filmmaking enables remote collaboration among artists, highlighting the importance of exploring creative collaborative networks.

FIG. 11 is a structural diagram of a creative collaborative network 1100 in accordance with aspects of the present disclosure. As shown in FIG. 11, the creative collaborative network 1100 is designed with several key components that enhance the efficiency and effectiveness of remote collaboration, including but not limited to the following: one or more digital collaboration tools 1110; one or more cloud-based asset management systems 1120; an AI filmmaking workflow platform 1130; and security and intellectual property management system 1140.

Digital Collaboration Tools 1110: These tools provide a virtual workspace where team members can communicate, brainstorm, and share ideas in real time. Platforms such as video conferencing, chat applications, and digital whiteboards are essential for maintaining a consistent flow of communication, allowing for dynamic discussions and quick decision-making, which are crucial in the creative process. For example, various tools like Slack, Microsoft Teams, and Zoom integrate various communication methods, including chart, video calls, and file sharing, into a single platform to make collaboration easier and more efficient. These platforms also integrate with other digital tools, creating a seamless workflow where communication is directly linked to project management, file storage, and more. Digital tools enable real-time collaboration on documents, designs, and code, allowing multiple people to work together simultaneously, reducing the need for lengthy back-and-forth and speeding up the collaboration process.

Cloud-Based Asset Management Systems 1120: Cloud-based systems are vital for organizing, storing, and sharing large volumes of digital assets, such as scripts, storyboards, 3D models, and raw footage. These systems enable teams to access and update assets from any location, ensuring that everyone is working with the most current materials. This not only streamlines the workflow, but also reduces the risk of version control issues and data loss. For example, cloud computing allows for centralized storage of resources, such as files, data, and tools, that can be accessed by collaborators anywhere, anytime. This facilitates the sharing of large datasets, software, and collaborative environments, which is essential for complex projects like software development, research, and creative industries.

AI Filmmaking Workflow Platform 1130: The various AI tools (the “modules”) of the AI filmmaking workflows (200, 300, 400) described above can be provided on the AI filmmaking workflow platform 1130 and integrated into the network so that artists and filmmakers have access to the capability that they are looking for to complete the creative process of production. For example, artists can find facility to capture real-world elements such as actors' performances, and they can access virtual production environments where remote teams can direct and film scenes as if they were on-site.

Security and Intellectual Property Management System 1140: To protect creative works and ensure that intellectual property rights are respected, the network is equipped with advanced security protocols and digital rights management tools. This ensures that all shared assets and communications are secure, maintaining the integrity and confidentiality of the project.

As shown in FIG. 11, the creative collaborative network 1100 also includes a communication network 150 (e.g., wired, wireless, mobile, the Internet, etc.), as well as one or more user devices 1160 (e.g., user devices 1-N) and one or more servers 1170 (e.g., servers 1-N) that are communicatively coupled with the communication network 1150 to enable the techniques described herein. The communication network 150 can enable the director and other participants to create, communicate, store, and share files, data, and information, as well as to access the AI filmmaking workflow platform 1130 itself. In some example embodiments, the AI filmmaking workflow platform 1130 (or at least a part thereof) can be obtained (e.g., downloaded) and executed locally on the user devices 1160. In some other example embodiments, the AI filmmaking workflow platform 1130 (or at least a part thereof) can be accessed remotely via the one or more servers 1170 and executed remotely on the one or more servers 1170 on behalf of the users.

It should be understood that one or more of these components and devices shown in FIG. 11 and one or more aspects of the techniques described herein with reference to the preceding figures can be implemented using hardware (e.g., computers, mobile devices, tablets, etc.) including one or more processors (e.g., CPUs, GPUs, processors, microprocessors, etc.) and one or more memories (e.g., storage devices), or can be implementing using software (e.g., applications, programs, instructions, algorithms, models, etc.), or a combination of hardware and software. Although shown as separate boxes in FIG. 11, this is merely for ease of illustration and explanation, and it should be understood that various features, tools, modules, components, functions, and the like can be provided together on or accessed using a same computing device in some examples, or can be separate and distributed between multiple devices in other examples.

Together, these platforms, devices, components, and users form a comprehensive network that supports the diverse and dynamic needs of AI-assisted filmmaking, enabling a more collaborative, flexible, and efficient movie production process.

Thus, the digitization techniques described above can fundamentally transform collaborative networks by breaking down traditional barriers, improving communication, and integrating advancing technologies like AI. This creates new opportunities for innovation, efficiency, and creativity, enabling teams to collaborate in ways that are more dynamic, inclusive, and effective than ever before. Digital platforms allow individuals and organizations from around the world to collaborate in real-time, regardless of location. This global connectivity fosters diverse collaborations that bring together different cultures, expertise, and perspectives, thereby driving innovation and creativity. With digital tools, collaboration is no longer limited by time zones or office hours. Teams can work asynchronously, passing tasks between time zones to maintain continuous progress on projects.

In addition, AI tools can automate and optimize task delegation within a collaborative network, ensuring that the right people are working on the right tasks based on their skills, availability, and past performance. This makes collaboration more efficient and reduces bottlenecks. For example, AI-driven tools like ChatGPT can assist with brainstorming, content creation, data analysis, and more. These tools can act as collaborators, offering suggestions, automating routine tasks, and even generating new ideas, thereby expanding the capabilities of human teams. Digitization also enables teams to collaboratively analyze large datasets in real-time, using tools like Google Analytics, Tableau, or custom machine-learning models. This shared access to data insights drives informed decision-making and more effective collaboration. By analyzing data on team members' skills, work habits, and preferences, AI tools can help create personalized collaboration networks, ensuring that team members are paired with tasks and collaborators that match their strengths, leading to more productive and satisfying collaborations.

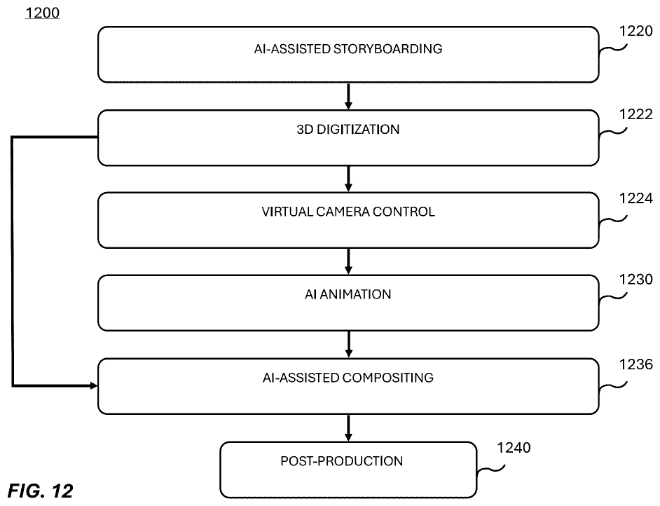

FIG. 12 is a flowchart illustrating steps of a first method 1200 for AI-assisted filmmaking, according to the first example embodiment of the present disclosure.

At 1220, the method includes performing AI-assisted storyboarding to generate one or more images of a storyboard, one or more prompts associated with the storyboard, and a guide based on a script.

At 1222, the method includes performing 3D digitization to generate a 3D model for a scene based on the script and the guide resulting from the AI-assisted storyboarding process.

At 1224, the method includes performing virtual camera control to generate a prompt based on the guide and the 3D model resulting from the 3D digitization process.

At 1230, the method includes performing AI animation to generate a first video based on the one or more images of the storyboard and the one or more prompts resulting from the AI-assisted storyboarding, as well as the prompt resulting from the 3D digitization process and the virtual camera control.

At 1236, the method includes performing AI-assisted compositing to generate a composited video based on the first video resulting from the AI animation process and a LoRA model resulting from the 3D digitization process.

At 1240, the method includes performing one or more post-production processes with respect to the composited video resulting from the AI-assisted compositing process to generate a complete film (or an extended video clip).

Thus, the first method 1200 can be considered a “3D digitization mode” that relates to the AI filmmaking workflow 200 according to the first example embodiment described above with reference to FIG. 2. The first method 1200 can be implemented using the computing devices and components of the creative collaborative network 1100 described above with reference to FIG. 11, which include combinations of hardware and software as the corresponding structure for implementing the various “modules” of the AI filmmaking workflow platform, as noted.

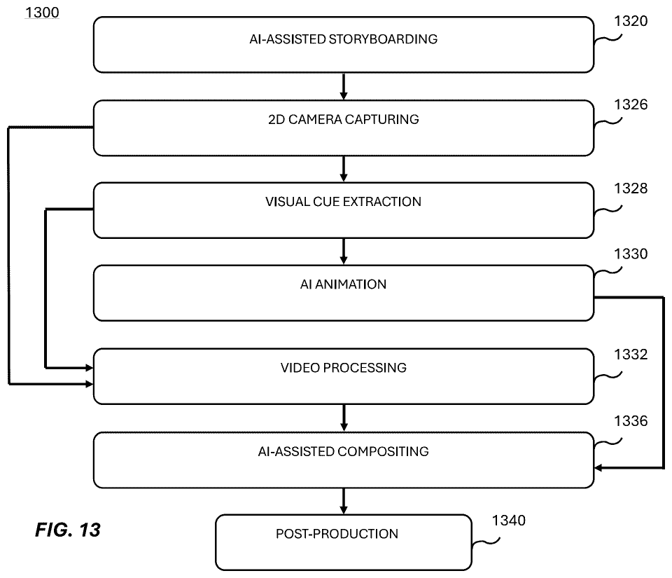

FIG. 13 is a flowchart illustrating steps of a second method 1300 for AI-assisted filmmaking, according to the second example embodiment of the present disclosure.

At 1320, the method includes performing AI-assisted storyboarding to generate one or more images of a storyboard, one or more prompts associated with the storyboard, and a guide based on a script.

At 1326, the method includes performing 2D camera capturing to generate a second video based on the script and the guide resulting from the AI-assisted storyboarding process.

At 1328, the method includes performing visual cue extraction to generate a prompt based on the guide and the second video resulting from the 2D camera capturing.

At 1330, the method includes performing AI animation to generate a first video based on the one or more images of the storyboard and the one or more prompts resulting from the AI-assisted storyboarding, as well as the prompt resulting from the 2D camera capturing and the visual cue extraction process.

At 1332, the method includes performing video processing to generate a third video based on the second video resulting from the 2D camera capturing and one or more visual cues resulting from the visual cue extraction process.

At 1336, the method includes performing AI-assisted compositing to generate a composited video based on the first video resulting from the AI animation process and the third video resulting from the video processing.

At 1340, the method includes performing one or more post-production processes with respect to the composited video resulting from the AI-assisted compositing process to generate a complete film (or an extended video clip).

Thus, the second method 1300 can be considered a “2D camera capturing mode” that relates to the AI filmmaking workflow 300 according to the first example embodiment described above with reference to FIG. 3. The second method 1300 can be implemented using the computing devices and components of the creative collaborative network 1100 described above with reference to FIG. 11, which include combinations of hardware and software as the corresponding structure for implementing the various “modules” of the AI filmmaking workflow platform, as noted.

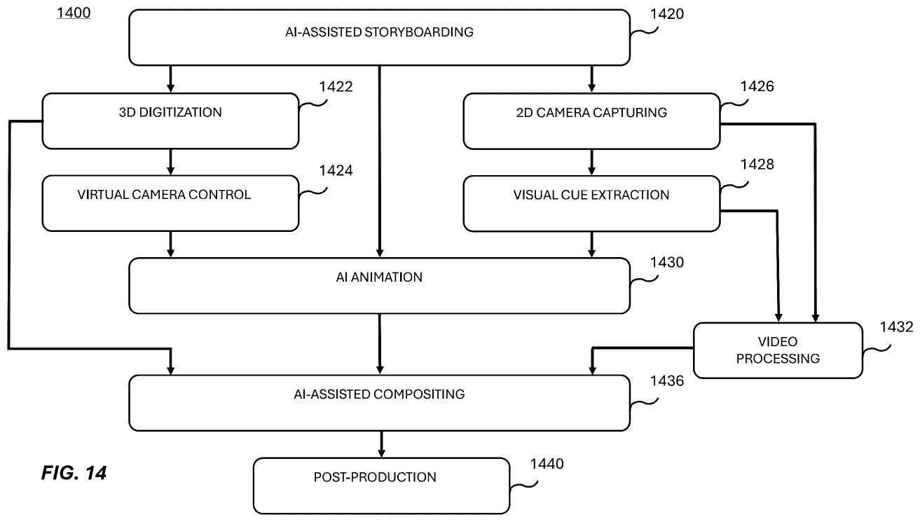

FIG. 14 is a flowchart illustrating steps of a third method 1400 for AI assisted filmmaking, according to the third example embodiment of the present disclosure.

At 1420, the method includes performing AI-assisted storyboarding to generate one or more images of a storyboard, one or more prompts associated with the storyboard, and a guide based on a script.

At 1422, the method includes performing 3D digitization to generate a 3D model for a scene based on the script and the guide resulting from the AI-assisted storyboarding process. At 1424, the method includes performing virtual camera control to generate a prompt based on the guide and the 3D model resulting from the 3D digitization process.

At 1426, the method includes performing 2D camera capturing to generate a second video based on the script and the guide resulting from the AI-assisted storyboarding process. At 1428, the method includes performing visual cue extraction to generate a prompt based on the guide and the second video resulting from the 2D camera capturing. At 1432, the method includes performing video processing to generate a third video based on the second video resulting from the 2D camera capturing and one or more visual cues resulting from the visual cue extraction process.

At 1430, the method includes performing AI animation to generate a first video based on the one or more images of the storyboard and the one or more prompts resulting from the AI-assisted storyboarding, as well as the prompt resulting from the 3D digitization process and the virtual camera control and the prompt resulting from the 2D camera capturing and the visual cue extraction process.

At 1436, the method includes performing AI-assisted compositing to generate a composited video based on the first video resulting from the AI animation process, a LoRA model resulting from the 3D digitization process, and the third video resulting from the video processing.

At 1440, the method includes performing one or more post-production processes with respect to the composited video resulting from the AI-assisted compositing process to generate a complete film (or an extended video clip).

Thus, the third method 1400 relates to the AI filmmaking workflow 400 according to the third example embodiment described above with reference to FIG. 4. The third method 1400 can be implemented using the computing devices and components of the creative collaborative network 1100 described above with reference to FIG. 11, which include combinations of hardware and software as the corresponding structure for implementing the various “modules” of the AI filmmaking workflow platform, as noted.

In the example of FIG. 14, it should be appreciated that certain operations of the 3D digitization mode (1422, 1424) can be performed, and additionally or alternatively, certain operations of the 2D camera capturing mode (1426, 1428, 1432) can be performed. These processes can be performed simultaneously or at different times, and can be performed by a single person (e.g., the director) or by multiple different individuals. These processes can both be performed for the same scene, or only one of the 3D digitization mode or the 2D camera capturing mode may be used for a particular scene. Whether the 3D digitization mode, the 2D camera capturing mode, or both will be used at any given time or for any given scene or sequence can depend on the director's narrative needs and creative vision, and on which techniques are more appropriate for a given situation.

In summary, a novel AI filmmaking framework that is designed to facilitate future creative collaborative networks has been introduced with reference to the accompanying figures. The AI filmmaking workflow platform has already been utilized to create pioneering AI films, such as the love story “Next Stop Paris” and the sci-fi short “Message in a Bot,” for example. This framework's innovative approach to AI digitization, decomposition, and composition of film elements enables unprecedented control and flexibility in the creative process, setting a new standard for AI-assisted filmmaking. As filmmakers increasingly adopt AI-assisted filmmaking frameworks and related AI technology, creative collaboration networks will play significant roles in growing the community, and thus the future of filmmaking, characterized by a ten-fold increase in efficiency that can be realized in an unprecedentedly short period.

It is noted that the above-described example embodiments are merely intended to be illustrative in nature, and should not be construed as limiting the scope of the present disclosure, the inventive concepts, or the accompanying claims in any way.

What is claimed is:

1. A computer-implemented system for artificial intelligence (AI) assisted filmmaking, the System comprising:
an AI-assisted storyboarding module configured to generate one or more images of a storyboard, one or more prompts associated with the storyboard, and a guide based on a script;
a 3D digitization module configured to generate a 3D model for a scene based on the script and the guide;
a virtual camera controller configured to generate a prompt associated with the 3D model for the scene for controlling virtual camera settings;
an AI animation module configured to generate a first video based on the one or more images of the storyboard and the one or more prompts associated with the storyboard, as well as the prompt associated with the 3D model for the scene for controlling the virtual camera settings; and
an AI-assisted compositing module configured to generate a composited video based on the first video generated by the AI animation module and a low-rank adaptation (LoRA) model.

2. The system of claim 1, wherein the 3D digitization module is further configured to generate the LoRA model based on the script and the guide,
wherein the 3D model for the scene represents a digitized 3D environment and the LoRA model represents a digitized character.

3. The system of claim 1, further comprising:
a 2D camera capturing module configured to generate a second video based on the script and the guide; and
a visual cue extraction module configured to generate a prompt associated with the second video.

4. The system of claim 3, wherein the AI animation module is configured to generate the first video based on the one or more images of the storyboard and the one or more prompts associated with the storyboard, as well as the prompt associated with the second video.

5. The system of claim 4, wherein the visual cue extraction module is further configured to generate one or more visual cues based on the second video, the system further comprising:
a video processing module configured to generate a third video based on the second video and the one or more visual cues.

6. The system of claim 5, wherein the AI-assisted compositing module is further configured to generate the composited video based on the first video generated by the AI animation module and the third video generated by the video processing module.

7. The system of claim 1, wherein the AI-assisted compositing module is further configured to add visual effects, sound effects, or a combination thereof in the composited video.

8. The system of claim 1, further comprising:
a post-production module configured to generate and output a complete film based on the composited video generated by the AI-assisted compositing module.

9. The system of claim 8, wherein the post-production module is configured to perform one or more post-processing operations with respect to the composited video generated by the AI-assisted compositing module to generate the complete film.

10. A computer-implemented method for artificial intelligence (AI) assisted filmmaking, the method comprising:
generating, via an AI-assisted storyboarding module, one or more images of a storyboard, one or more prompts associated with the storyboard, and a guide based on a script;
generating, via a 3D digitization module, a 3D model for a scene based on the script and the guide;
generating, via a virtual camera controller, a prompt associated with the 3D model for the scene for controlling virtual camera settings;
generating, via an AI animation module, a first video based on the one or more images of the storyboard and the one or more prompts associated with the storyboard, as well as the prompt associated with the 3D model for the scene for controlling the virtual camera settings; and
generating, via an AI-assisted compositing module, a composited video based on the first video and a low-rank adaptation (LoRA) model.

11. The method of claim 10, further comprising:
generating, via the 3D digitization module, the LoRA model based on the script and the guide,
wherein the 3D model for the scene represents a digitized 3D environment and the LoRA model represents a digitized character.

12. The method of claim 10, further comprising:
generating, via a 2D camera capturing module, a second video based on the script and the guide; and
generating, via a visual cue extraction module, a prompt associated with the second video.

13. The method of claim 12, further comprising:
generating, via the AI animation module, the first video based on the one or more images of the storyboard and the one or more prompts associated with the storyboard, as well as the prompt associated with the second video.

14. The method of claim 13, further comprising:
generating, via the visual cue extraction module, one or more visual cues based on the second video; and
generating, via a video processing module, a third video based on the second video and the one or more visual cues.

15. The method of claim 14, further comprising:
generating, via the AI-assisted compositing module, the composited video based on the first video and the third video.

16. The method of claim 10, further comprising:
adding, via the AI-assisted compositing module, visual effects, sound effects, or a combination thereof in the composited video.

17. The method of claim 10, further comprising:
generating, via a post-production module, a complete film based on the composited video; and
outputting the complete film for review.

18. The method of claim 17, further comprising:
performing, via the post-production module, one or more post-processing operations with respect to the composited video to generate the complete film.
